(19) United States
(12) Patent Application Publication
(10) Pub. No.: US 2009/0289775 A1
(43) Pub. Date: Nov. 26, 2009

(54) FITTING ROOM TERMINAL, JOB SUPPORTING SYSTEM, AND NOTIFYING METHOD

(75) Inventors: Takahide Kubota, Shizuoka (JP); Kenya Hiramatsu, Shizuoka (JP); Akio Hiruma, Shizuoka (JP); Kenji Shimizu, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/465,737

(22) Filed: May 14, 2009

(30) Foreign Application Priority Data
May 21, 2008 (JP) 2008-133041

(51) Int. Cl. G06K 7/00

(52) U.S. Cl. 340/10.6

(57) ABSTRACT

A notifying unit performs notifying operation on the outside of a fitting room. A display unit displays information in the fitting room. An operation input unit receives operation input of the information in the fitting room. An RFID reader writer performs radio communication with an RFID tag, which is attached to a commodity and stores data of a commodity ID for identifying the commodity, and sets a radio communication range in the inside of the fitting room. A control unit (i) acquires, from a stock file that stores data of stock information of commodities identified by commodity IDs in association with the commodity IDs, data of the stock information corresponding to a commodity ID output by the RFID reader writer and (ii) causes the display unit to display the stock information, the data of which is acquired from the stock file, and causes the notifying unit to perform the notifying operation when it is selected by operation input in the operation input unit to cause the display unit to display the stock information of a commodity identified by the commodity ID output by the RFID reader writer.

### CROSS-REFERENCE TO RELATED APPLICATION

This application is based upon and claims the benefit of priority from Japanese Patent Application No. 2008-133041, filed on May 21, 2008, the entire contents of which are incorporated herein by reference.

### TECHNICAL FIELD

The present invention relates to a fitting room terminal used by a customer in a fitting room, a job supporting system, and a notifying method.

### BACKGROUND

In an apparel store that sells apparel articles, a customer tries an apparel article on in a fitting room to consider purchase of the apparel article. JP-A-2005-189918 discloses a fitting room in which a CCD camera and a display are set. A customer photographs a figure of the customer wearing a tried-on apparel article and causes a display to display a photographed image. This allows the customer to check the figure of the customer wearing the tried-on apparel article from an angle at which the customer cannot see the figure with a mirror.

When a color and a size of the tried-on apparel article do not match the customer, the customer asks, from the inside of the fitting room, a store clerk on the outside of the fitting room whether there is a commodity of the same type with different color and size.

However, no store clerk is extremely often present near the fitting room. When no store clerk is present near the fitting room, since the customer has to go out from the fitting room to find another commodity, the customer feels discomfort. When no store clerk is present near the fitting room, some customer gives up finding another commodity and leaves the apparel store. This is a loss of a sales chance and therefore is disadvantage for the apparel store.

To solve the problem, it is conceivable that the store clerk frequently walks around near the fitting room and appropriately calls to customer in the fitting room. However, the store clerk cannot learn, from the outside of the fitting room, timing when the customer desires a help. Therefore, it is difficult for the store clerk to call to the customer in the fitting room at timing desired by the customer.

### SUMMARY

It is an object of the present invention to allow a store clerk to call to a customer in a fitting room at timing appropriate for the customer.

According to an aspect of the present invention, there is provided a fitting room terminal including: a notifying unit that performs notifying operation on the outside of a fitting room; a display unit that displays information in the fitting room; an operation input unit that receives operation input of the information in the fitting room; an RFID reader writer that performs radio communication with an RFID tag, which is attached to a commodity and stores data of a commodity ID for identifying the commodity, and sets a radio communication range in the inside of the fitting room; and a control unit that (i) acquires, from a stock file that stores data of stock information of commodities identified by commodity IDs in association with the commodity IDs, data of the stock information corresponding to a commodity ID output by the RFID reader writer and (ii) causes the display unit to display the stock information, the data of which is acquired from the stock file, and causes the notifying unit to perform the notifying operation when it is selected by operation input in the operation input unit to cause the display unit to display the stock information of a commodity identified by the commodity ID output by the RFID reader writer.

According to another aspect of the present invention, there is provided a job supporting system including: a server including a stock file that stores data of stock information of commodities identified by commodity IDs in association with the commodity IDs; and a fitting room terminal that communicates with the server. The fitting room terminal includes: a notifying unit that performs notifying operation on the outside of a fitting room; a display unit that displays information in the fitting room; an operation input unit that receives operation input of the information in the fitting room; an RFID reader writer that performs radio communication with an RFID tag, which is attached to a commodity and stores data of a commodity ID for identifying the commodity, and sets a radio communication range in the inside of the fitting room; and a control unit that (i) acquires, from the stock file, data of the stock information corresponding to a commodity ID output by the RFID reader writer and (ii) causes the display unit to display the stock information, the data of which is acquired from the stock file, and causes the notifying unit to perform the notifying operation when it is selected by operation input in the operation input unit to cause the display unit to display the stock information of a commodity identified by the commodity ID output by the RFID reader writer.

According to still another aspect of the present invention, there is provided a notifying method including: a control unit acquiring, from a stock file that stores data of stock information of commodities identified by commodity IDs in association with the commodity IDs, data of the stock information corresponding to a commodity ID output by an RFID reader writer, the RFID reader writer performing radio communication with an RFID tag, which is attached to a commodity and stores data of a commodity ID for identifying the commodity, and setting a radio communication range in a fitting room; and the control unit causing the display unit to display the stock information, the data of which is acquired from the stock file, and causing the notifying unit to perform notifying operation when it is selected by operation input in an operation input unit to cause the display unit to display the stock information of a commodity identified by the commodity ID output by the RFID reader writer, the display unit displaying information in the fitting room, the operation input unit receiving operation input of information in the fitting room and the notifying unit performing the notifying operation on the outside of the fitting room.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a system diagram of a job supporting system;

FIG. 2 is a perspective view of a fitting room including a fitting room terminal;

FIG. 3 is a block diagram of a hardware configuration of the fitting room terminal;

FIG. 4 is a schematic diagram of a data structure of a commodity file;

FIG. 5 is a schematic diagram of a data structure of a stock file;

FIG. 6 is a flowchart of an example of processing executed by a CPU of the fitting room terminal;

FIG. 7 is a schematic diagram of a state of a RAM during the processing executed by the CPU of the fitting room terminal;

FIG. 8 is a schematic diagram of a screen example of an LCD of the fitting room terminal that displays a selection screen;

FIG. 9 is a schematic diagram of a screen transition example of the LCD of the fitting room terminal in stock information display processing;

FIG. 10 is a schematic diagram of a data structure of a history file; and

FIG. 11 is a schematic diagram of a screen example of an LCD of a client terminal that displays a notification screen.

### DETAILED DESCRIPTION

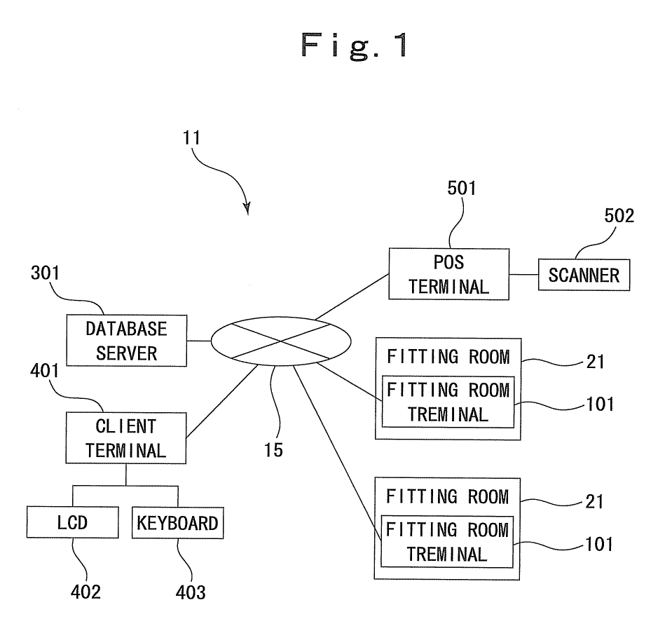

An embodiment of the present invention is explained with reference to FIGS. 1 to 11. This embodiment is an example of application of the present invention to a fitting room terminal 101 configuring a job supporting system 11 installed in an apparel store.

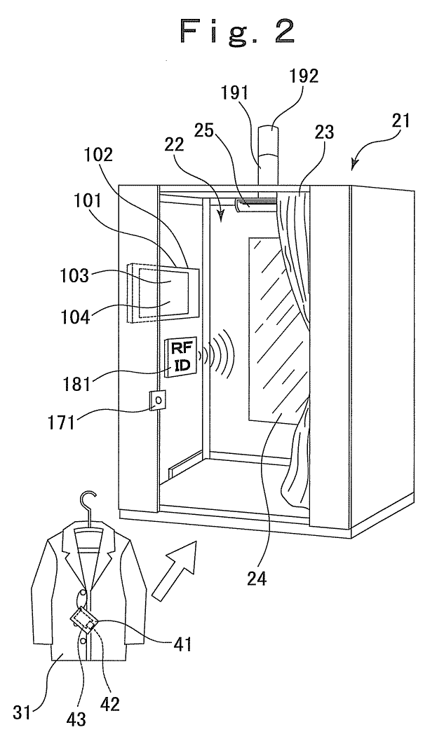

FIG. 1 is a system diagram of the job supporting system 11. A store that installs the job supporting system 11 is an apparel store. The store displays a large number of apparel articles 31 (see FIG. 2) as commodities.

A register counter (not shown in the figure) near an exit of the store supports a POS terminal 501. The POS terminal 501 includes a scanner 502 that scans and outputs data of a commodity ID peculiar to each commodity. An RFID tag 41 (see FIG. 2) attached to the apparel article 31 (see FIG. 2), which is a commodity, shows a commodity ID in a form of a code symbol. The POS terminal 501 executes commodity sales data processing.

The POS terminal 501 is connected to a database server 301 and a client terminal 401 via a network line 15. The database server 301 is located in a backyard and the like of the store. The client terminal 401 is located in the backyard of the store or on the register counter.

The database server 301 is a general server computer. A display that displays information, a keyboard for inputting information, and a pointing device (all of which are not shown in the figure) are connected to a housing of the database server 301. The housing of the database server 301 incorporates an HDD (not shown in the figure), which stores various files, as a storage device. An installation place of the database server 301 may be the outside of the store.

The client terminal 401 is a notebook personal computer having an openable and closable housing. The client terminal 401 includes an LCD 402 that displays information as a second display unit, a keyboard 403 for inputting information, and a track pad (not shown in the figure) for moving a mouse pointer displayed by the LCD 402. Other components of the client terminal 401 are the same as those of a general notebook personal computer. Therefore, explanation of the client terminal 401 is omitted.

In the store as the apparel store, plural fitting rooms 21, each of which is used by a customer when the customer tries on the apparel article 31 (see FIG. 2), which is a commodity, is disposed. The customer tries the apparel article 31 on in the fitting room 21 to consider purchase of the commodity. The fitting room 21 includes a fitting room terminal 101.

FIG. 2 is a perspective view of the fitting room 21 including the fitting room terminal 101. A shape of the fitting room 21 is a rectangular parallelepiped opened in a part of an upper surface and a part of a front surface. The opening in the front surface of the fitting room 21 is an entrance 22 through which a customer comes in and out. The fitting room 21 includes a cloth curtain 23 arranged at the entrance 22. The cloth curtain 23 is opened and closed by a not-shown curtain rail. In the fitting room 21, for example, a sliding door may be arranged in the entrance 22 instead of the curtain 23. In FIG. 2, since the curtain 23 is open, the inside of the fitting room 21 can be visually recognized from the entrance 22. A full-length mirror 24 that reflects the customer when the customer tries an apparel article on is located on a wall on a rear side in the fitting room 21. A light 25, which is a fluorescent lamp, is located in a position above the full-length mirror 24 in the fitting room 21.

The fitting room terminal 101 is located on one sidewall in the fitting room 21. The fitting room terminal 101 displays information to the customer in the fitting room 21 and receives operation input from the customer.

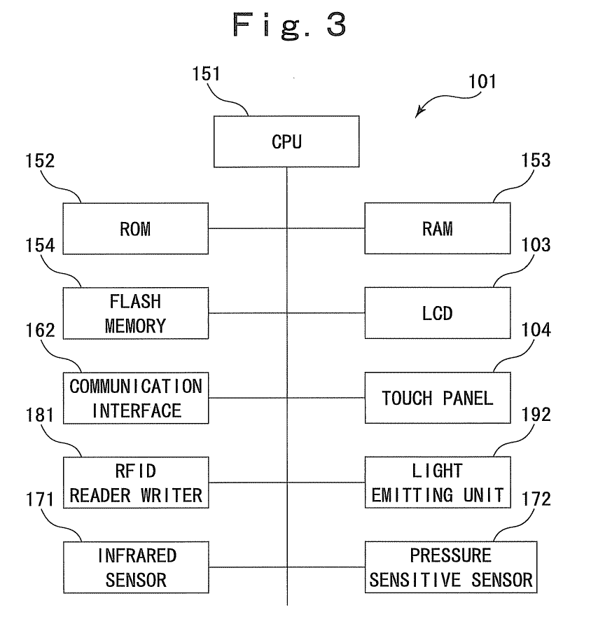

The fitting room terminal 101 includes a thick flat housing 102. The housing 102 includes an LCD 103 serving as a display unit. A touch panel 104 serving as an operation input unit is arranged on a display surface of the LCD 103. The fitting room terminal 101 incorporates a communication interface 162 (see FIG. 3) for performing data communication with the database server 301 and the like via the network line 15.

An RFID reader writer 181 for performing radio communication with the RFID tag 41 is located in a position below the fitting room terminal 101 in the fitting room 21. The RFID reader writer 181 performs data communication with the fitting room terminal 101 located above the RFID reader writer 181.

The RFID tag 41, with which the RFID reader writer 181 performs radio communication, is attached to the apparel article 31 as a price tag. When the customer brings the apparel article 31 into the fitting room 21, the RFID reader writer 181 performs radio communication with the RFID tag 41 attached to the apparel article 31 in the fitting room 21. A communication range of the RFID reader writer 181 is the inside of the fitting room 21.

The RFID tag 41 is a passive tag that does not incorporate a battery. The RFID tag 41 incorporates an IC chip 42 and a coil-like tag antenna 43. The IC chip 42 stores data of a commodity ID for identifying a commodity.

The RFID reader writer 181 communicates with the RFID tag 41 according to an electromagnetic induction system that uses, for example, a 13.56 MHz frequency band. The RFID reader writer 181 communicates with the RFID tag 41 by using voltage induced by induced magnetic fluxes of an antenna coil (not shown in the figure) of the RFID reader writer 181 and the tag antenna 43. In a communication state, the RFID reader writer 181 acquires and outputs the data of the commodity ID stored by the IC chip 42. The data of the commodity ID output by the RFID reader writer 181 is input to a CPU 151 (see FIG. 3) of the fitting room terminal 101.

A slim columnar pole 191 is erected on a rear surface of the fitting room 21. The pole 191 has, at a distal end thereof, a light emitting unit 192 serving as a notifying unit that selectively emits light of blue, red, and green. The light emitting unit 192 is connected to the fitting room terminal 101 by a not-shown cable passing through the pole 191. The light emitting unit 192 is subjected to operation control by the CPU 151 (see FIG. 3) of the fitting room terminal 101. In a state in which the light emitting unit 192 is not subjected to the operation control by the CPU 151, the light emitting unit 192 does not perform light emitting operation.

An infrared sensor 171 serving as a human sensor that detects a customer passing though the entrance 22 is located on one side of the entrance 22. The infrared sensor 171 is a so-called pyroelectric infrared sensor. The infrared sensor 171 detects an infrared ray emitted by a human body of the customer passing through the entrance 22 and outputs a detection result. The infrared sensor 171 is connected to the fitting room terminal 101 via a not-shown cable. The detection result output by the infrared sensor 171 is input to the CPU 151 (see FIG. 3) of the fitting room terminal 101.

A floor of the fitting room 21 has overlapping two floor plates, although not shown in the figure. The overlapping two floor plates hold plural pressure sensitive sensors 172 (see FIG. 3). When the customer enters the fitting room 21 and steps on the floor, any one of the pressure sensitive sensors 172 receives pressure. The pressure sensitive sensor 172 detects a pressure change and outputs a detection result. The pressure sensitive sensor 172 is connected to the fitting room terminal 101 via a not-shown cable. A detection result output by the pressure sensitive sensor 172 is input to the CPU 151 (see FIG. 3) of the fitting room terminal 101.

The pressure sensitive sensor 172 is a sensor for determining that the customer passing through the entrance 22 is present in the fitting room 21. Therefore, the pressure sensitive sensor 172 may be any other sensors as long as it is possible to determine that the customer is present in the fitting room 21. For example, the curtain 23 of the fitting room 21 is closed when the customer is present in the fitting room 21 and is opened when the customer is not present in the fitting room 21. Therefore, the pressure sensitive sensor 172 maybe a sensor that detects “close” of the curtain 23 and outputs a detection result. When the fitting room 21 includes a sliding door in the entrance 22, the pressure sensitive sensor 172 may be a sensor that detects “close” of the door and outputs a detection result. When the door can be “locked” from an inner side of the fitting room 21, the pressure sensitive sensor 172 may be a sensor that detects “lock” of the door and outputs a detection result. This is because the customer in the fitting room 21 always “locks” the door.

FIG. 3 is a block diagram of a hardware configuration of the fitting room terminal 101. The fitting room terminal 101 includes the CPU 151 serving as a control unit that executes various kinds of arithmetic processing and controls units of the fitting room terminal 101. The CPU 151 is connected to a ROM 152 that permanently stores stationary data such as computer programs, a RAM 153 that rewritably stores variable data and is used as a work area by the CPU 151, and a flash memory 154 as a nonvolatile memory that holds data content even if the fitting room terminal 101 is turned off. The flash memory 154 stores various computer programs and various files.

The LCD 103, the touch panel 104, the communication interface 162, the infrared sensor 171, the pressure sensitive sensor 172, the RFID reader writer 181, and the light emitting unit 192 are connected to the CPU 151 via various input and output circuits (all of which are not shown in the figure), respectively. The CPU 151 controls the operation of the LCD 103, the touch panel 104, the communication interface 162, the infrared sensor 171, the pressure sensitive sensor 172, the RFID reader writer 181, and the light emitting unit 192. Only one pressure sensitive sensor 172 is shown in FIG. 3. However, actually, as explained above, the plural pressure sensitive sensors 172 are provided.

The CPU 151 of the fitting room terminal 101 accesses, during processing executed according to the description of the computer programs, files stored by the HDD (not shown in the figure) of the database server 301. The database server 301 is connected to the fitting room terminal 101 via the network line 15.

Various files (a commodity file F1, a stock file F2, etc.) stored by the HDD (not shown in the figure) of the database server 301 are explained.

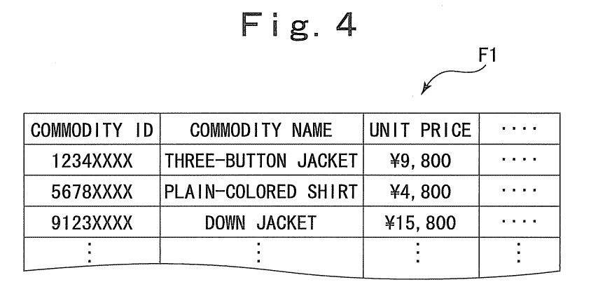

FIG. 4 is a schematic diagram of a data structure of the commodity file F1. The commodity file F1 stores “commodity name” and “unit price” of a commodity in association with “commodity ID” peculiar to each commodity. “Commodity ID” is an eight digit number. For example, a commodity ID for identifying a three-button jacket is “1234XXXX”. The last four digits “XXXX” in “1234XXXX” are arbitrary numbers. For example, both “12345678” and “12341234” are commodity IDs for identifying the three-button jacket. The POS terminal 501 accesses the commodity file F1 during execution of commodity sales data processing and acquires “commodity name” and “unit price” from the commodity file F1. The commodity sales data processing is processing for acquiring “commodity name” and “unit price”, which correspond to a commodity ID scanned by the scanner 502, from the commodity file F1 and calculating a settlement amount by, for example, totaling “unit price”. The fitting room terminal 101 does not access the commodity file F1.

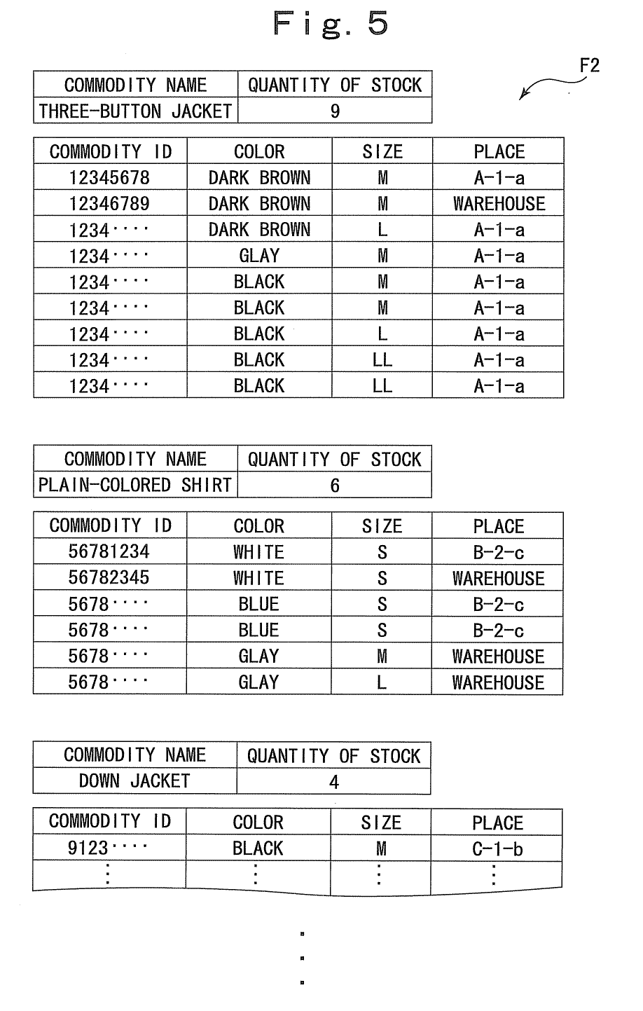

FIG. 5 is a schematic diagram of a data structure of the stock file F2. The stock file F2 stores “commodity name” and “quantity of stock” for each commodity (apparel article 31) displayed in the store.

The stock file F2 stores “commodity ID” for each commodity of the entire stock in the store. The stock file F2 stores “color” and “size”, which are attribute information, concerning individual commodities identified by the commodity IDs in association with the respective “commodity IDs”.

The stock file F2 stores “place” in association with “commodity ID”. The stock file F2 stores, as “place”, place numbers (A-1-a, B-2-c, etc.) for identifying commodity display places. When commodities are stored in a warehouse, the stock file F2 stores information [warehouse] as “place”.

For example, as shown in FIG. 5, the quantity of stock of three-button jackets is nine. Among the nine three-button jackets, concerning a three-button jacket identified by a commodity ID 12345678, a color is dark brown, a size is M, and a place is A-1-a.

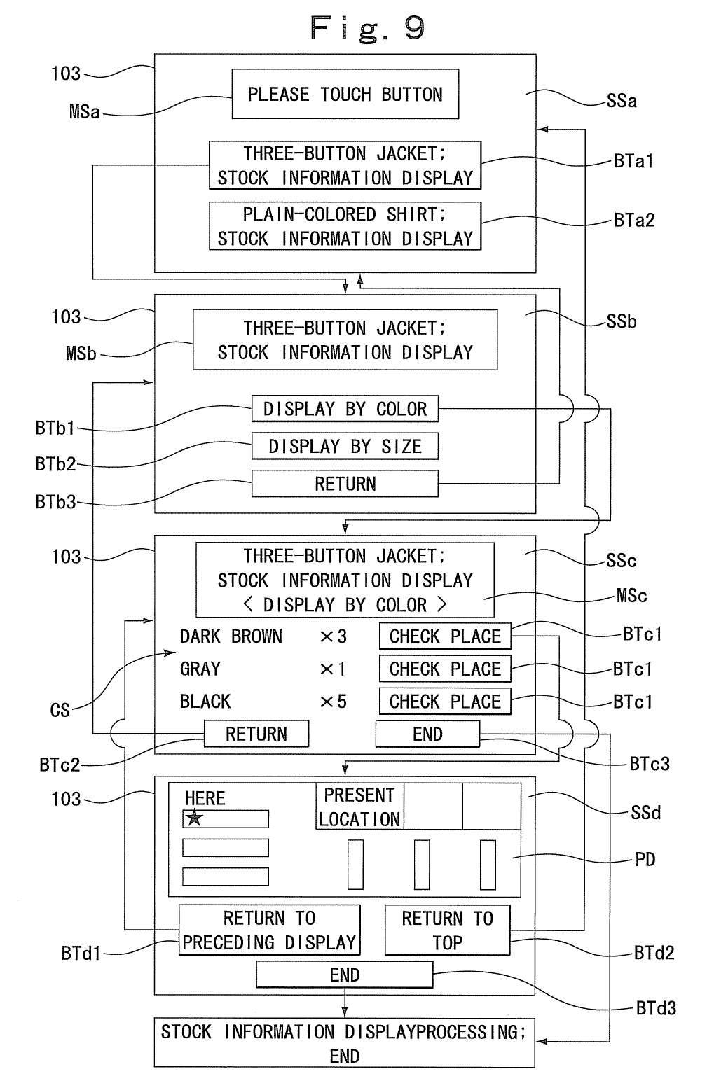

In the following explanation, data stored by the stock file F2 may be referred to as stock information data. The stock information data is data as a basis of stock information that the fitting room terminal 101 causes the LCD 103 to display. The fitting room terminal 101 causes, in response to a request of the customer in the fitting room 21, the LCD 103 to display information concerning the stock of the apparel article 31 brought in to the fitting room 21 by the customer (see FIG. 9).

The commodity file F1 and the stock file F2 may be one file.

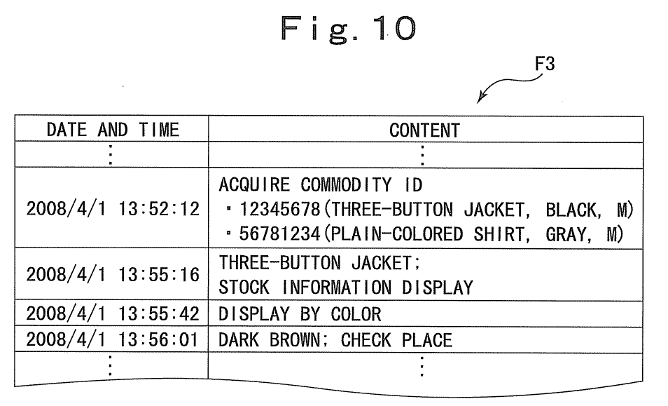

The HDD (not shown in the figure) of the database server 301 stores a history file F3 (see FIG. 10). The history file F3 is explained later.

Processing executed by the CPU 151 of the fitting room terminal 101 when the customer brings one or two or more apparel articles 31 displayed in the store into the fitting room 21 to consider purchase of the apparel article(s) 31 is explained.

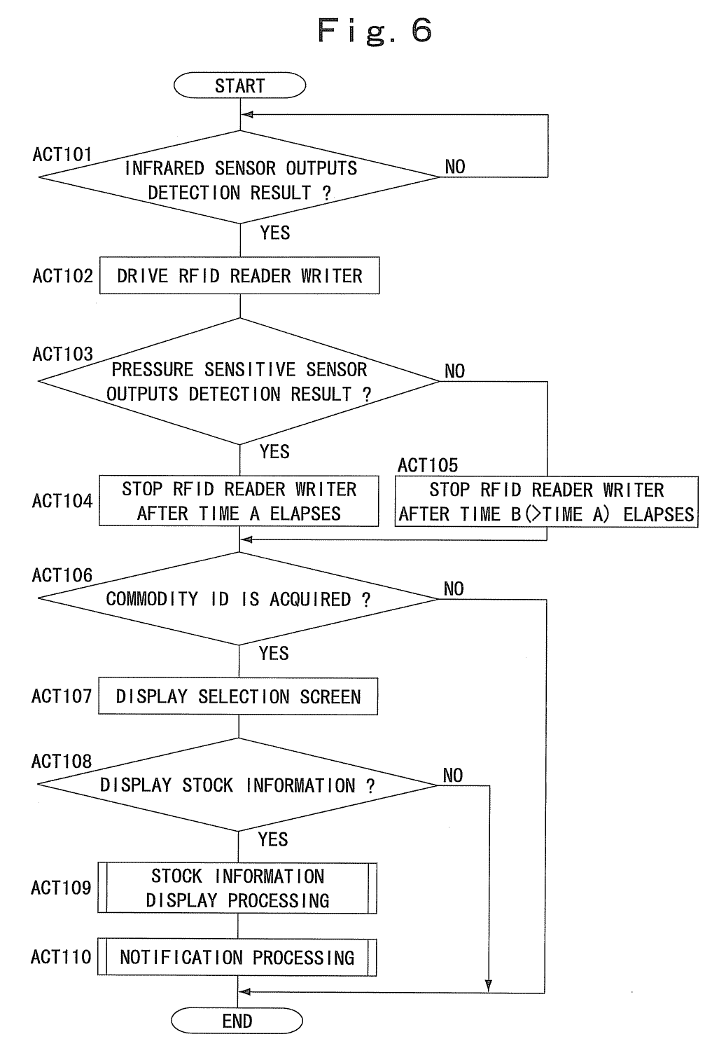

FIG. 6 is a flowchart of an example of the processing executed by the CPU 151 of the fitting room terminal 101. The CPU 151 of the fitting room terminal 101 waits for input of a detection result output by the infrared sensor 171 (Act 101). When the customer brings the apparel article 31 into the fitting room 21, the customer always passes through the entrance 22. The infrared sensor 171 detects an infrared ray emitted by the body of the customer passing through the entrance 22 and outputs a detection result. The detection result output by the infrared sensor 171 is input to the CPU 151 of the fitting room terminal 101.

The CPU 151 of the fitting room terminal 101 determines that the detection result output by the infrared sensor 171 is input (Yes in Act 101). The CPU 151 of the fitting room terminal 101 drives the RFID reader writer 181 (Act 102) and waits for input of a detection result output by the pressure sensitive sensor 172 (Act 103).

The customer passing through the entrance 22 to enter the fitting room 21 steps on the floor of the fitting room 21. When the customer steps on the floor of the fitting room 21, pressure is applied to any one of the pressure sensitive sensors 172 arranged on the floor of the fitting room 21. The pressure sensitive sensor 172 detects a pressure change and outputs a detection result. The detection result output by the pressure sensitive sensor 172 is input to the CPU 151 of the fitting room terminal 101.

When the pressure sensitive sensor 172 outputs the detection result (Yes in Act 103), the CPU 151 of the fitting room terminal 101 stops the driving of the RFID reader writer 181 after fixed time (time A) elapses from the driving of the RFID reader writer 181 (Act 102) (Act 104).

When the pressure sensitive sensor 172 does not output the detection result (No in Act 103), the CPU 151 of the fitting room terminal 101 also stops the driving of the RFID reader writer 181 after fixed time (time B) elapses from the driving of the RFID reader writer 181 (Act 102) (Act 105).

The time A is shorter than the time B. This means that the CPU 151 of the fitting room terminal 101 stops the driving of the RFID reader writer 181 earlier when the pressure sensitive sensor 172 outputs the detection result (Yes in Act 103) after the driving of the RFID reader writer 181 (Act 102) than when the pressure sensitive sensor 172 does not output the detection result (No in Act 103) after the driving of the RFID reader writer 181 (Act 102).

When the customer passes through the entrance 22 and enters the fitting room 21 bringing the apparel article 31, the RFID reader writer 181 performs radio communication with the RFID tag 41 of the apparel article 31 in the fitting room 21 until the driving is stopped. The RFID reader writer 181 acquires data of a commodity ID from the IC chip 42 of the RFID tag 41 and outputs the data to the fitting room terminal 101. The CPU 151 of the fitting room terminal 101 acquires the data of the commodity ID (Yes in Act 106). The RAM 153 stores the acquired data of the commodity ID together with acquisition date and time.

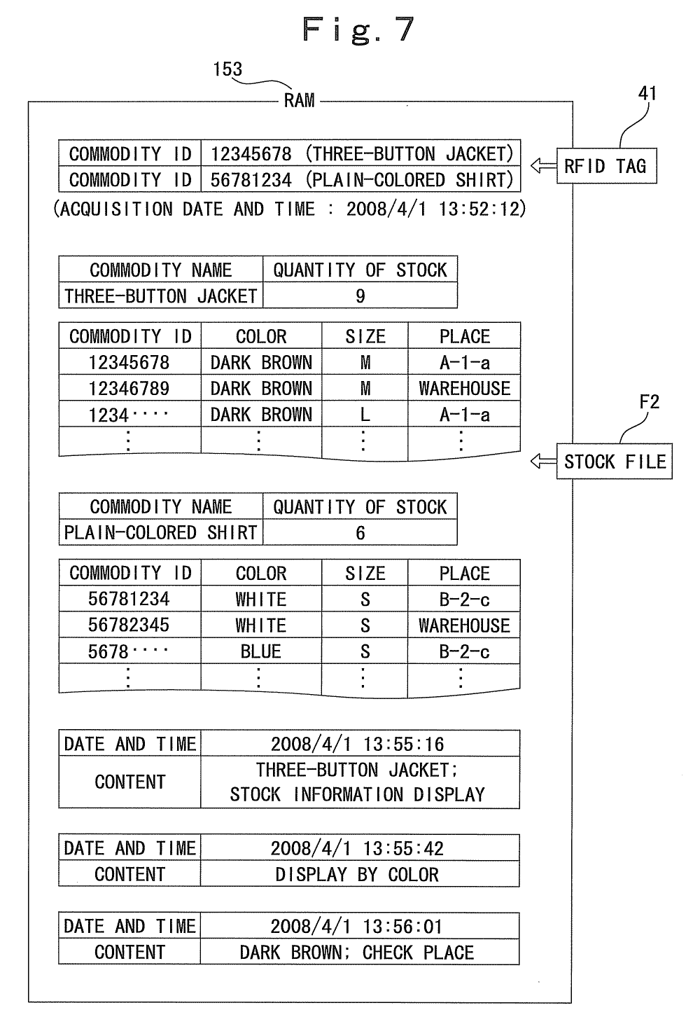

FIG. 7 is a schematic diagram of a state of the RAM 153 during the processing executed by the CPU 151 of the fitting room terminal 101. As shown in a first table from the top of the RAM 153 shown in FIG. 7, the RAM 153 of the fitting room terminal 101 stores the data of the commodity ID, which is acquired from the RFID tag 41, together with the acquisition date and time. When the customer brings two or more apparel articles 31 into the fitting room 21, the CPU 151 of the fitting room terminal 101 acquires data of commodity IDs from the RFID tags 41 of the apparel articles 31. The RAM 153 stores data of plural commodity IDs. The RAM 153 stores two commodity IDs (12345678 “three-button jacket” and 56781234 “plain-colored shirt”).

Subsequently, the CPU 151 of the fitting room terminal 101 accesses the stock file F2. The CPU 151 of the fitting room terminal 101 acquires, concerning the commodities (“three-button jacket” and “plain-colored shirt”) identified by the commodity IDs stored by the RAM 153, stock information data from the stock file F2 and causes the RAM 153 to store the stock information data as shown in second to fifth tables from the top of the RAM 153 shown in FIG. 7.

Referring back to FIG. 6, when the customer does not bring the apparel article 31 into the fitting room 21 because, for example, the customer does not enter the fitting room 21, the RFID reader writer 181 does not perform radio communication with the RFID tag 41. Therefore, the CPU 151 of the fitting room terminal 101 finishes the processing without acquiring data of a commodity ID (No in Act 106).

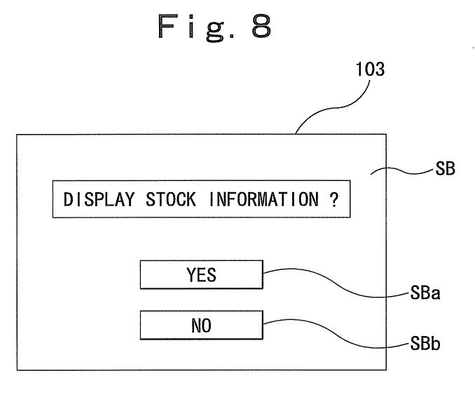

The CPU 151 of the fitting room terminal 101 causes the LCD 103 to display a selection screen SB (see FIG. 8) (Act 107).

FIG. 8 is a schematic diagram of a screen example of the LCD 103 of the fitting room terminal 101 that displays the selection screen SB. The selection screen SB includes, as shown in FIG. 8, characters “display stock information?”, an affirmative button SBa for displaying “Yes”, and a negative button SBb for displaying “No”. The customer touches and designates the affirmative button SBa and the negative button SBb through the touch panel 104. After reading the characters “display stock information?” included in the selection screen SB, the customer in the fitting room 21 selects one of the affirmative button SBa and the negative button SBb by touching the button on the touch panel 104. When the customer is satisfied with the tried-on apparel article 31, the customer selects the negative button SBb. On the other hand, when the customer is dissatisfied with the tried-on apparel article 31 (e.g., a color does not match, a size does not match, etc.), the customer selects the affirmative button SBa to learn presence or absence of stock of the apparel articles 31 of the same type having different colors and different sizes.

Referring back to FIG. 6, when the CPU 151 of the fitting room terminal 101 determines that the negative button SBb is selected by touch operation on the touch panel 104, the CPU 151 determines that stock information is not displayed (No in Act 108) and finishes processing. When the CPU 151 of the fitting room terminal 101 determines that the affirmative button SBa is selected by touch operation on the touch panel 104, the CPU 151 determines that stock information is displayed (Yes in Act 108) and starts stock information display processing (Act 109).

FIG. 9 is a schematic diagram of a screen transition example of the LCD 103 of the fitting room terminal 101 in the stock information display processing. The CPU 151 of the fitting room terminal 101 causes, referring to the stock information data stored by the RAM 153 (see the second to fifth tables from the top of the RAM 153 shown in FIG. 7), the LCD 103 to display stock information SSa concerning the apparel article 31 in the fitting room 21.

As shown in a first row from the top of FIG. 9, the stock information SSa includes, together with a message MSa “please touch the button”, a stock information display button BTa1 for displaying “three-button jacket; stock information display” and a stock information display button BTa2 for displaying “plain-colored shirt; stock information display”.

When the CPU 151 determines that the stock information display button BTa1 for displaying “three-button jacket; stock information display” is selected by touch operation on the touch panel 104, the CPU 151 causes the RAM 153 to store display content (“three-button jacket; stock information display”) of the stock information display button BTa1 together with touching date and time as shown in a sixth table from the top of the RAM 153 shown in FIG. 7

Subsequently, the CPU 151 causes, referring to the stock information data stored by the RAM 153 (see the second to fifth tables from the top of the RAM 153 shown in FIG. 7), the LCD 103 to display stock information SSb concerning the apparel article 31 (the three-button jacket), selection of which is determined.

As shown in a second row from the top of FIG. 9, the stock information SSb includes, together with a message MSb “three-button jacket; stock information display”, a display-by-color button BTb1 for displaying “display by color”, a display-by-size button BTb2 for displaying “display by size”, and a return button BTb3 for displaying “return”.

When the CPU 151 determines that the return button BTb3 is selected by touch operation on the touch panel 104, the CPU 151 returns the display of the LCD 103 to the immediately preceding stock information SSa (see the first row from the top of FIG. 9).

When the CPU 151 determines that the display-by-color button BTb1 is selected by touch operation on the touch panel 104 rather than the return button BTb3, the CPU 151 causes the RAM 153 to store display content (“display by color”) of the display-by-color button BTb1 together with touching date and time as shown in a seventh table from the top of the RAM 153 shown in FIG. 7.

Subsequently, the CPU 151 causes, referring to the stock information data stored by the RAM 153 (see the second to fifth tables from the top of the RAM 153 shown in FIG. 7), the LCD 103 to display stock information SSc including information concerning stock by color of the three-button jackets.

As shown in a third row from the top of FIG. 9, the stock information SSc includes a message MSc “three-button jacket; stock information display <display by color>” and three kinds of stock display by color CS “dark brown×3”, “gray×1”, and “black×5”. Further, the stock information SSc includes three place confirmation buttons BTc1 for displaying “place confirmation” adjacent to the respective kinds of stock display by color CS. The stock information SSc includes a return button BTc2 for displaying “return” and an end button BTc3 for displaying “end” in a lower part in the screen.

When the CPU 151 determines that the return button BTc2 is selected by touch operation on the touch panel 104, the CPU 151 returns the display of the LCD 103 to the immediately preceding stock information SSb (see the second row from the top of FIG. 9). When the CPU 151 determines that the end button BTc3 is selected by touch operation on the touch panel 104, the CPU 151 deletes the stock information SSc and finishes the stock information display processing.

When the CPU 151 determines that any one of the place confirmation buttons BTc1 is selected by touch operation on the touch panel 104, the CPU 151 causes the RAM 153 to store selection content (“dark brown; place confirmation”) together with touching date and time as shown in an eighth table from the top of the RAM 153 shown in FIG. 7.

The CPU 151 causes, referring to “place” included in the stock information data stored by the RAM 153 (see the second to fifth tables from the top of the RAM 153 shown in FIG. 7), the LCD 103 to display stock information SSd including place display PD concerning a commodity to be selected.

As shown in a fourth row from the top of FIG. 9, the place display PD included in the stock information SSd indicates, with characters “here” and an asterisk, a display place of a commodity, for which the place confirmation button BTc1 is touched, on a selling floor image in which a place sign is registered in advance. The flash memory 154 of the fitting room terminal 101 stores data of the selling floor image in advance.

Further, the stock information SSd includes a first return button BTd1 for displaying “return to preceding display”, a second return button BTd2 for displaying “return to top”, and an end button BTd3 for displaying “end”.

When the CPU 151 determines that the first return button BTd1 is selected by touch operation on the touch panel 104, the CPU 151 returns the display of the LCD 103 to the immediately preceding stock information SSc (see a third row from the top of FIG. 9). When the CPU 151 determines that the second return button BTd2 is selected by touch operation on the touch panel 104, the CPU 151 returns the display of the LCD 103 to the stock information SSa (see the first row from the top of FIG. 9). When the CPU 151 determines that the end button BTd3 is selected by touch operation on the touch panel 104, the CPU 151 erases the display of the LCD 103 and finishes the stock information display processing.

In finishing the stock information display processing, the CPU 151 of the fitting room terminal 101 accesses the history file F3 (see FIG. 10) and causes the history file F3 to store the data that the CPU 151 causes the RAM 153 to store during the stock information display processing.

FIG. 10 is a schematic diagram of a data structure of the history file F3. As shown in FIG. 10, the history file F3 stores data stored by the RAM 153 during the stock information display processing (see the sixth to eighth tables from the top of the RAM 153 shown in FIG. 7). The history file F3 does not store the stock information data acquired from the stock file F2 and stored by the RAM 153 (see the second to fifth tables from the top of the RAM 153 shown in FIG. 7). The history file F3 also stores the data of the commodity ID acquired from the RFID tag 41 and stored by the RAM 153 (see the first table from the top of the RAM 153 shown in FIG. 7). The history file F3 stores a commodity name, a color, and a size identified by the commodity ID (acquired from the stock information data stored by the RAM 153 (see the second to fifth tables from the top of the RAM 153 shown in FIG. 7).

A store clerk can check content of the data stored by the history file F3 by, for example, causing the LCD 402 of the client terminal 401 to display the content. In this case, a CPU (not shown in the figure) of the client terminal 401 accesses the history file F3 via the network line 15, acquires the data stored by the history file F3, and causes the LCD 402 to provide the acquired data as information display. The LCD 402 sorts and displays, in order of “date and time”, “content” stored by the history file F3.

The store clerk checks data content of the history file F3 via the LCD 402 of the client terminal 401. This allows the store clerk to learn, like a by-product, information concerning what kind of apparel article 31 the customer brings into the fitting room 21 and tries on and information concerning what kind of stock information display the customer requests about the apparel article 31 brought into the fitting room 21. The store clerk can grasp, on the basis of the information, what kind of commodity the customer desires.

Referring back to FIG. 6, after the stock information display processing (Act 109), the CPU 151 of the fitting room terminal 101 performs notification processing (Act 110). As the notification processing, the CPU 151 of the fitting room terminal 101 causes the light emitting unit 192 of the pole 191 to emit blue light. The blue light emission of the light emitting unit 192 notifies the store clerk that the customer in the fitting room 21 needs a help.

The store clerk who looks at the light emitting unit 192 emitting the blue light can approach the entrance 22 of the fitting room 21 where the pole 191 having the light emitting unit 192 is erected and call to the customer in the fitting room 21 through the curtain 23 which is closed.

When the store clerk calls to the customer in the fitting room 21, the customer is finishing the stock information display processing. In other words, the customer in the fitting room 21 is dissatisfied with the apparel article 31 brought into the fitting room 21 and causes the LCD 103 to display stock information of commodities of different colors and the like. Therefore, the customer in the fitting room 21 is considered to be about to go to a display place to take another commodity or call the store clerk. Therefore, it can be expected that “since the customer in the fitting room 21 is called to by the store clerk at a stage of the light emission of the light emitting unit 192 after the end of the stock information display processing, the customer feels that the store clerk calls to the customer at extremely good timing and feels that the service of the store is extremely satisfactory”.

The customer is considered to perform only operation for stock information display in the fitting room 21 and feel that the customer does not perform any special operation for calling the store clerk. In other words, the customer is not aware that the customer calls the store clerk. Therefore, it can be expected that “the customer has an impression that timing for calling to the store clerk is extremely accurate”.

The light emitting unit 192 emits blue light according to selection of “display by color”, emits red light according to selection of “display by size”, and emits green light in other cases.

The store clerk who looks at the light emitting unit 192 that emit blue light can learn that the customer in the fitting room 21 causes the LCD 103 to display the stock-by-color display CS. Therefore, the store clerk can call to the customer “how do you like the color of the commodity?” Therefore, it can be expected that “the customer feels that the store clerk calls to the customer about a point the customer is dissatisfied with in trying the commodity on and the customer has a good impression of the store clerk”.

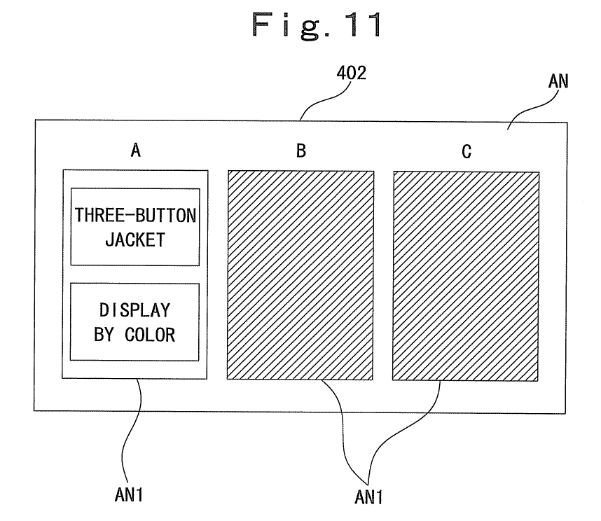

Another example of the notification processing (Act 110 of the flowchart shown in FIG. 6) is explained. A form of notification performed in the notification processing is not limited to the light emission of the light emitting unit 192. The notification performed in the notification processing may be, for example, notification via the LCD 402 of the client terminal 401. In the case of the notification via the LCD 402 of the client terminal 401, as the notification processing, the CPU 151 of the fitting room terminal 101 transmits a command to the client terminal 401 via the network line 15. The CPU (not shown in the figure) of the client terminal 401 causes, according to the command, the LCD 402 to display a notification screen AN (see FIG. 11).

FIG. 11 is a schematic diagram of a screen example of the LCD 402 of the client terminal 401 that displays the notification screen AN. The store includes three fitting rooms 21. The three fitting rooms 21 have names “A”, “B”, and “C”, respectively. The notification screen AN includes three kinds of fitting room state indication AN1 that indicate states of the three fitting rooms 21. The notification screen AN displays, above the respective kinds of fitting room state indication AN1, the names of the fitting rooms 21 corresponding thereto.

The fitting room state indication AN of “B” and the fitting room state indication AN1 of “C” included in the notification screen AN shown in FIG. 11 are in a blackout state. The blackout state indicates a state in which no customer is present in the fitting room 21 and no command is transmitted from the fitting room terminal 101 to the client terminal 401.

The fitting room state indication AN1 of “A” included in the notification screen AN shown in FIG. 11 is released from the blackout state and includes character display “three-button jacket” and character display“display by color”. In this case, the CPU 151 of the fitting room terminal 101 of the fitting room 21 named “A” includes, in a command transmitted to the client terminal 401, an indication that “display by color” is performed concerning “three-button jacket”. When the CPU (not shown in the figure) of the client terminal 401 receives the command, the CPU causes the LCD 402 to display, in the notification screen AN, the fitting room state indication AN1 of “A” including the character display “three-button jacket” and the character display “display by color”.

When the customer selects “display by size” by touching the touch panel 104, the fitting room state indication AN1 includes character display “display by size”.

The store clerk who looks at the notification screen AN can approach the entrance 22 of the fitting room 21 named “A”and call to the customer in the fitting room 21 through the closed curtain 23.

Since the store clerk confirms the fitting room state indication AN1 included in the notification screen AN, the store clerk can call to the customer in the fitting room 21 with limited content of the call. For example, since the fitting room state indication AN1 of “A” includes the character display “three-button jacket” and “display by color”, the store clerk can call to the customer in the fitting room 21 “how is the three-button jacket?” or “is there any point you dissatisfied with concerning the color of the three-button jacket?” Therefore, it can be expected that “the customer feels that the store clerk calls to the customer about a point the customer is dissatisfied with in trying the commodity on and the customer has a good impression of the store clerk”.

Obviously, numerous modifications and variations of the present invention are possible in light of the above teachings. It is therefore to be understood that within the scope of the appended claims, the invention may be practiced otherwise than as specifically described herein.

What is claimed is:

1. A fitting room terminal comprising:
a notifying unit that performs notifying operation on an outside of a fitting room;
a display unit that displays information in the fitting room;
an operation input unit that receives operation input of the information in the fitting room;
an RFID reader writer that performs radio communication with an RFID tag, which is attached to a commodity and stores data of a commodity ID for identifying the commodity, and sets a radio communication range in an inside of the fitting room; and
a control unit that (i) acquires, from a stock file that stores data of stock information of commodities identified by commodity IDs in association with the commodity IDs, data of the stock information corresponding to a commodity ID output by the RFID reader writer and (ii) causes the display unit to display the stock information, the data of which is acquired from the stock file, and causes the notifying unit to perform the notifying operation when it is selected by operation input in the operation input unit to cause the display unit to display the stock information of a commodity identified by the commodity ID output by the RFID reader writer.

2. The terminal according to claim 1, wherein
the stock information, the data of which is stored by the stock file, includes attribute information of the commodities, and
the control unit causes, in response to operation in the operation input unit, the display unit to display the stock information according to the attribute information.

3. The terminal according to claim 2, wherein
the notifying unit performs plural kinds of notifying operation, and
the control unit varies the notifying operation of the notifying unit according to the attribute information of the stock information that the control unit causes the display unit to display.

4. The terminal according to claim 3, wherein
the notifying unit is a light emitting unit that emits light in plural colors, and
the control unit causes the light emitting unit to emit light with an emitted light color varied according to the attribute information of the stock information that the control unit causes the display unit to display.

5. The terminal according to claim 4, wherein the light emitting unit is located at a distal end of a pole erected on the outside of the fitting room.

6. The terminal according to claim 3, wherein
the notifying unit is a second display unit that displays information on the outside of the fitting room, and
the control unit causes the second display unit to display fitting room state indication with a display form varied according to the attribute information of the stock information that the control unit causes the display unit to display.

7. The terminal according to claim 1, wherein
the notifying unit is a light emitting unit that emits light, and
the control unit causes the light emitting unit to emit light when the control unit causes the display unit to display the stock information.

8. The terminal according to claim 7, wherein the light emitting unit is located at a distal end of a pole erected on the outside of the fitting room.

9. A job supporting system comprising:
a server including a stock file that stores data of stock information of commodities identified by commodity IDs in association with the commodity IDs; and
a fitting room terminal that communicates with the server,
wherein
the fitting room terminal includes:
a notifying unit that performs notifying operation on an outside of a fitting room;
a display unit that displays information in the fitting room;
an operation input unit that receives operation input of the information in the fitting room;
an RFID reader writer that performs radio communication with an RFID tag, which is attached to a commodity and stores data of a commodity ID for identifying the commodity, and sets a radio communication range in an inside of the fitting room; and
a control unit that (i) acquires, from the stock file, data of the stock information corresponding to a commodity ID output by the RFID reader writer and (ii) causes the display unit to display the stock information, the data of which is acquired from the stock file, and causes the notifying unit to perform the notifying operation when it is selected by operation input in the operation input unit to cause the display unit to display the stock information of a commodity identified by the commodity ID output by the RFID reader writer.

10. The system according to claim 9, wherein
the stock information, the data of which is stored by the stock file, includes attribute information of the commodities, and
the control unit causes, in response to operation in the operation input unit, the display unit to display the stock information according to the attribute information.

11. The system according to claim 10, wherein
the notifying unit performs plural kinds of notifying operation, and
the control unit varies the notifying operation of the notifying unit according to the attribute information of the stock information that the control unit causes the display unit to display.

12. The system according to claim 11, wherein
the notifying unit is a light emitting unit that emits light in plural colors, and
the control unit causes the light emitting unit to emit light with an emitted light color varied according to the attribute information of the stock information that the control unit causes the display unit to display.

13. The system according to claim 12, wherein the light emitting unit is located at a distal end of a pole erected on the outside of the fitting room.

14. The system according to claim 11, wherein
the notifying unit is a second display unit that displays information on the outside of the fitting room, and
the control unit causes the second display unit to display fitting room state indication with a display form varied according to the attribute information of the stock information that the control unit causes the display unit to display.

15. The system according to claim 9, wherein
the notifying unit is a light emitting unit that emits light, and
the control unit causes the light emitting unit to emit light when the control unit causes the display unit to display the stock information.

16. The system according to claim 15, wherein the light emitting unit is located at a distal end of a pole erected on the outside of the fitting room.

17. A notifying method comprising:
a control unit acquiring, from a stock file that stores data of stock information of commodities identified by commodity IDs in association with the commodity IDs, data of the stock information corresponding to a commodity ID output by an RFID reader writer, the RFID reader writer performing radio communication with an RFID tag, which is attached to a commodity and stores data of a commodity ID for identifying the commodity, and setting a radio communication range in a fitting room; and
the control unit causing the display unit to display the stock information, the data of which is acquired from the stock file, and causing the notifying unit to perform notifying operation when it is selected by operation input in an operation input unit to cause the display unit to display the stock information of a commodity identified by the commodity ID output by the RFID reader writer, the display unit displaying information in the fitting room, the operation input unit receiving operation input of information in the fitting room and the notifying unit performing the notifying operation on an outside of the fitting room.

18. The method according to claim 17, wherein
the stock information, the data of which is stored by the stock file, includes attribute information of the commodities, and
the control unit causes, in response to operation in the operation input unit, the display unit to display the stock information according to the attribute information.

19. The method according to claim 18, wherein
the notifying unit performs plural kinds of notifying operation, and
the control unit varies the notifying operation of the notifying unit according to the attribute information of the stock information that the control unit causes the display unit to display.

20. The method according to claim 19, wherein
the notifying unit is a light emitting unit that emits light in plural colors, and
the control unit causes the light emitting unit to emit light with an emitted light color varied according to the attribute information of the stock information that the control unit causes the display unit to display.

21. The method according to claim 19, wherein
the notifying unit is a second display unit that displays information on the outside of the fitting room, and
the control unit causes the second display unit to display fitting room state indication with a display form varied according to the attribute information of the stock information that the control unit causes the display unit to display.

22. The method according to claim 17, wherein
the notifying unit is a light emitting unit that emits light, and
the control unit causes the light emitting unit to emit light when the control unit causes the display unit to display the stock information.
